(19) United States
(12) Patent Application Publication
(10) Pub. No.: US 2005/0065858 A1
(43) Pub. Date: Mar. 24, 2005

(54) System and method for improved excess inventory distribution

(75) Inventors: Daniel L. Tenzer, Carlstadt, NJ (US); Lynn E. Turnbull, Hamburg, NJ (US); Malinda J. Keith, River Edge, NJ (US)

Correspondence Address: OSTROLENK FABER GERB & SOFFEN, 1180 AVENUE OF THE AMERICAS, NEW YORK, NY, 100368403, US

(73) Assignee: Argo Turboserve Corporation

(21) Appl. No.: 10/943,401

(22) Filed: Sep. 17, 2004

Related U.S. Application Data
(60) Provisional application No. 60/504,109, filed on Sep. 17, 2003.

(51) Int. Cl. G06F 17/60

(52) U.S. Cl. 705/26

(57) ABSTRACT

The invention provides spare parts information to a buyer over a communication network. Electronic spare parts inventory information is transmitted to an information processor from a plurality of surplus spare parts sellers that represent at least one spare part available for sale. Spare parts buyers transmit demand information representing demand for at least one spare part and the information processor matches the demand with the electronic inventory information. When a matched spare part is located, the information processor determines whether the part is available according to rules set forth from the surplus spare parts sellers. If the matched parts are available, the information processor provides electronic spare parts information representing the matched and available spare part to the spare parts buyer.

### CROSS-REFERENCE TO RELATED APPLICATIONS

The present invention is based on and claims priority to U.S. Provisional Patent Application Ser. No. 60/504,109, filed on Sep. 17, 2003 and entitled “SYSTEM AND METHOD FOR IMPROVED EXCESS INVENTORY DISTRIBUTION,” the entire contents of which are hereby incorporated by reference.

### FIELD OF THE INVENTION

The present invention relates generally to distributing excess inventory across a supply chain, and, more particularly, to Internet web site content distribution, and, more particularly, to generating cost savings by providing replacement parts and supplies to buyers from parties other than original equipment manufacturers and suppliers.

### BACKGROUND OF THE INVENTION

Virtually all industries use devices and machinery that perform many kinds of tasks and operations. The devices are made of many different parts which, over time, wear and deteriorate from normal use. Such parts require replacement in order for the respective devices to function.

In the prior art, a supplier is notified of a customer's demands for supplies, including parts that have worn out and require replacement. Typically, a customer provides a demand for spare parts that is transmitted to and received by the supplier. The supplier uses the demand to retrieve spare parts from a warehouse (or to build custom parts to order) and delivers the spare parts to a buyer for a price. Such parts are referred to herein as original equipment manufacturer (“OEM”) spare parts.

Referring to the reference figures in which like reference numerals refer to like elements, FIG. 1 is a block diagram illustrating parties in a prior art supply chain in which requests for spare parts are sent and received between the parties. In prior art supply chains, such as described above, the cost for spare parts including replacement parts and components for various devices is very high. Further, certain parts wear faster than others, thereby requiring a higher frequency of replacement. Suppliers thus have the ability to set their own price for the spare parts. Buyers are subjected to high prices for spare parts because suppliers of such parts recognize that buyers cannot locate the parts from alternative and less expensive sources. Replacement spare parts are, therefore, an expensive cost of doing business.

Frequently, buyers purchase replacement parts in anticipation of their future needs. For example, a particular electronic relay may be known to wear out and require replacement. Accordingly, a buyer purchases twenty five of the relays in order to be assured of an inventory of relays when a replacement is necessary. Often, a buyer over-purchases the number of parts it actually needs to insure that spare parts are available on a moment's notice. In the above example, the buyer has purchased twenty-five relays when, over a twenty-year period, it only requires ten relays.

### SUMMARY OF THE INVENTION

There is a need in the art, therefore, for a system and method for providing inventory of replacement parts and supplies that are less expensive than those provided by original equipment manufacturers. There is further a need in the art for a system and method to redistribute purchased parts that buyers do not need.

The present invention provides an Internet-based supply system that, based in part on buyers' respective pre-defined business rules, determines a cost effective way to meet daily spare parts requirements. The present invention employs a system and method that enables a process of procurement after, or in lieu of, a full scale inventory reduction/consolidation program of excess sellers' inventory is made available for (re)sale to buyers. The present invention enables inventories of spare parts to be sold to customers, and eliminates the expensive costs of spare parts typically charged by original equipment manufacturer spare part suppliers.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is a block diagram illustrating parties in a prior art spare parts supply chain;

FIG. 2 shows an example hardware arrangement in accordance with a preferred embodiment of the present invention;

FIG. 2A is a block diagram that illustrates parties comprising surplus spare parts sellers 104A;

FIG. 3 is a block diagram that shows the functional elements of information processor 102;

FIG. 4 is a block diagram that illustrates the flow of example spare parts information;

FIG. 5 shows a data table that illustrates results of algorithms applied according to the present invention;

FIG. 6 illustrates a sample display screen that is displayed on a surplus spare parts seller workstation in accordance with the present invention;

FIG. 7 illustrates a sample display screen that is displayed on a spare parts buyer workstation in accordance with a preferred embodiment of the present invention;

FIG. 8 illustrates display screen that is provided to a spare parts buyer workstation for matching purposes in accordance with a preferred embodiment of the present invention;

FIG. 9 illustrates an example Internet based display screen that is provided on a spare parts buyer workstation to determine particular matching values in accordance with a preferred embodiment of the present invention;

FIG. 10 shows an example e-mailed notification display screen that is provided to a spare parts buyer in accordance with an embodiment of the present invention;

FIG. 11 illustrates an example Internet-based display screen that provides results from a spare parts demand from a spare parts buyer;

FIG. 12 is another example display screen representing results returned from a demand for spare parts;

FIG. 13 is a block diagram that illustrates a high level flow of information between the various parties associated with the present invention; and

FIG. 14 is a flow chart that illustrates steps associated with example processes in accordance with a preferred embodiment of the present invention.

### DETAILED DESCRIPTION OF EMBODIMENTS OF THE INVENTION

The present invention provides a supply chain for the efficient transfer and distribution of excess inventory of previously owned spare parts. In accordance with the present invention, information regarding a seller's spare parts is transmitted to an information processor and used to make the spare parts available and/or to make spare parts procurement recommendations to buyers. Thus, the present invention functions as an Internet-based supply management system that manages and arranges information for buyers and sellers of surplus spare parts required for effective and efficient spare part procurement decisions. The invention makes recommendations to buyers for, for example, intra-utility inventory transfer recommendations, discounted procurement recommendations, cross-industry parts searching/matching recommendations, spare parts sourcing recommendations, and recommendations directed to personalized order fulfillment. Furthermore, the present invention provides buyers with reports that identify, for example, cost savings attributed to the present invention.

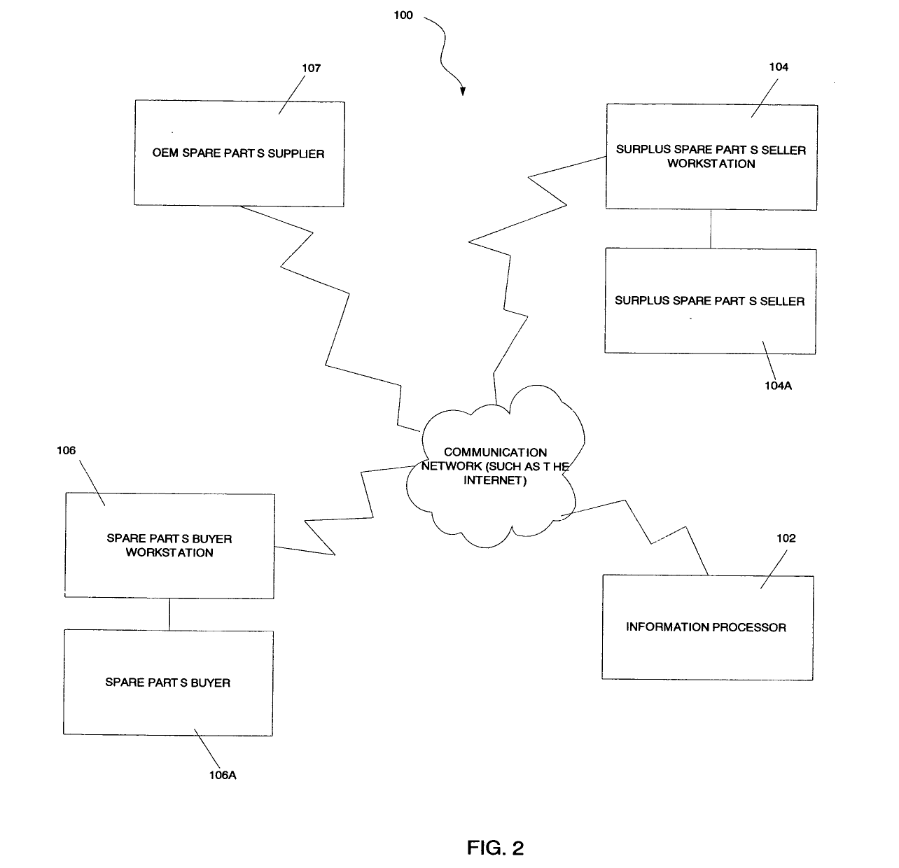

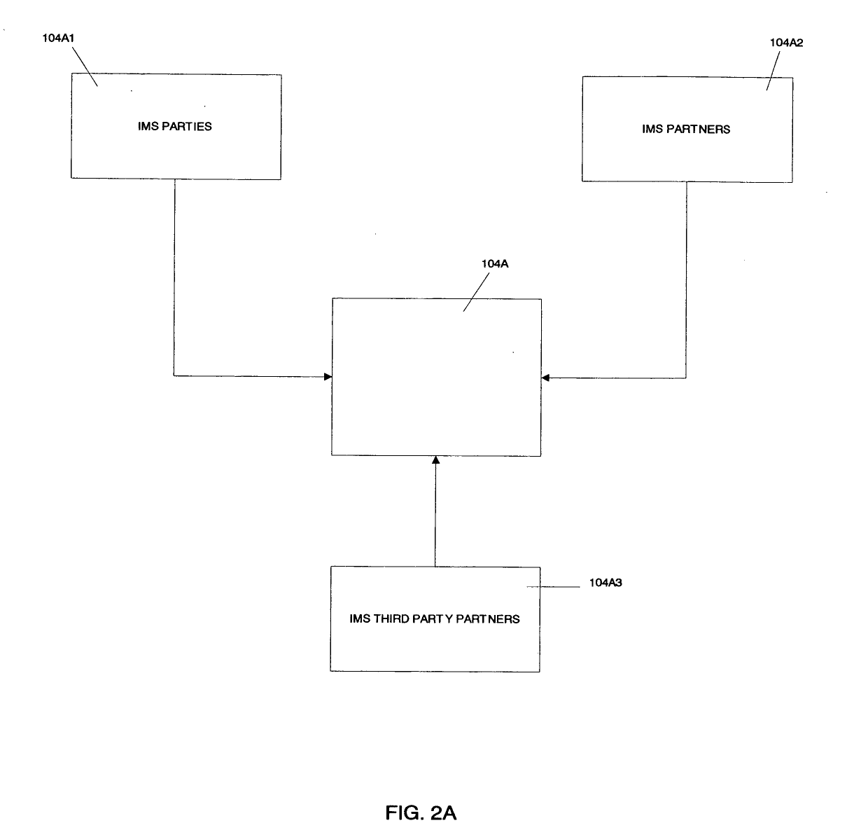

FIG. 2 shows an example preferred embodiment of the present invention, including a hardware arrangement for managing distribution of spare parts, and referred to herein, generally, as system 100. System 100 comprises at least one information processor 102, at least one surplus spare parts seller workstation 104 and operated by surplus spare parts sellers 104A, and at least one spare parts buyer workstation 106 and operated by spare parts buyer 106A, each of which is adapted to communicate over communication network 108. Information processor 102 preferably provides an Internet web site and includes a database and user interface for users of workstations 104 and 106.

In accordance with the present invention, a single party may be both a surplus spare parts seller 104A and a spare parts buyer 106A, depending upon a particular context. For example, a company operating in the nuclear power industry may have surplus spare parts inventory that it makes available according to the teachings herein. That same company may have a need for particular spare parts that it does not have in its inventory. Accordingly, the company functions as a surplus spare parts seller 104A when it provides its spare parts via the present invention, and also functions as a spare parts buyer 106A when it purchases spare parts via the present invention.

In accordance with a preferred embodiment of the present invention, commands and data are issued through communication network 108, and in response to the commands, information regarding spare parts flows between the various devices 102, 104. For example, information processor 102 receives demands from end-users for spare parts, and also receives levels or amounts of excess inventory of spare parts that are available from surplus spare parts sellers 104A. Also as shown in FIG. 2, system 100 is also adapted to include OEM spare parts supplier 107 when spare parts cannot be provided by alternative sources.

FIG. 2A is a block diagram that illustrates parties comprising surplus spare parts sellers 104A. In accordance with the present invention, surplus spare parts sellers 104A having surplus spare parts inventories transmit information to information processor 102 regarding their respective inventories. As shown in FIG. 2A, examples of surplus spare parts sellers 104A include inventory management services (“IMS”) parties 104A1, IMS partners 104A2, and IMS third-party partners 104A3.

As used herein, IMS parties 104A1 refer, generally, to parties that are proprietors of information processor 102, and may acquire surplus spare parts inventories from various parties. IMS parties 104A1 typically maintain surplus spare parts inventories for sale in accordance with the present invention. Electronic information regarding surplus spare parts inventories is stored in a database maintained by information processor 102.

Also as used herein, IMS partners 104A2 refer, generally, to companies that maintain surplus spare parts inventories and that operate within the same or similar industry as that of IMS party 104A1. For example, IMS party 104A1 operates in the nuclear power industry and purchases surplus spare parts inventory from various parties. Continuing with the present example, IMS partner 104A2 also operates within the nuclear power industry, and maintains one or more nuclear power plants.

Also as used herein, IMS third-party partners 104A3 refer, generally, to companies that maintain surplus spare parts inventories, and do not operate within the same industry as the IMS party 104A1. Continuing with the above example, an IMS third-party partner 104A3 is a company that maintains a surplus spare parts inventory used by the nuclear power industry, and operates within a different industry, such as the sewage treatment industry. IMS third-parties 104A3 maintain inventories of surplus spare parts that are usable by IMS parties 104A1 or 104A2.

Also as used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or more other modules in order to function.

As described in greater detail below, the information received by the information processor is processed and used to suggest sources for procuring spare parts to spare parts buyers 106A.

The present invention provides a surplus spare parts management system, often within a single industry, wherein spare parts buyers 106A and surplus spare parts sellers 104A transmit information to information processor 102 which functions as an order server. Information processor 102 compares spare parts buyer's 106A needs with existing inventory data that surplus spare parts sellers 104A in the industry have identified as available to sell.

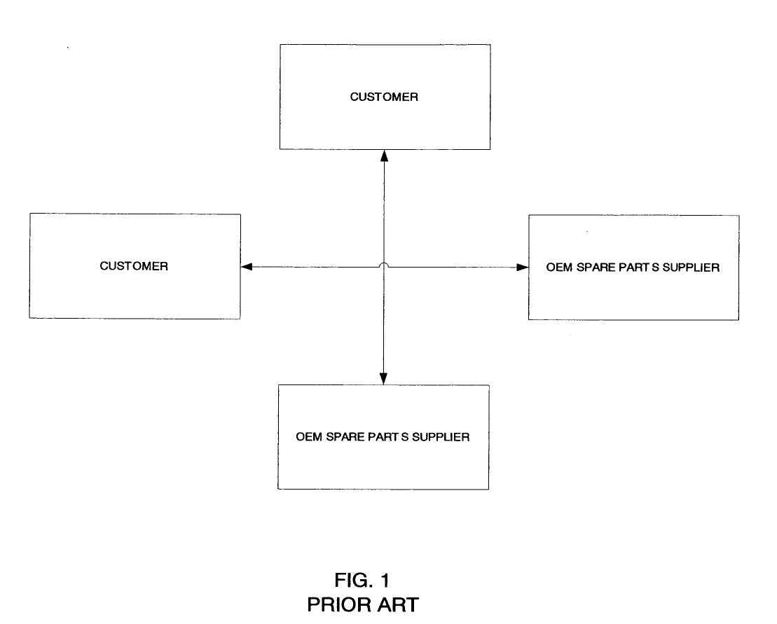

More particularly, the present invention maintains information requiring surplus spare parts inventories stored at a company warehouse, spare parts inventory that has been procured from various companies, and various and alternate sources of supply (i.e., IMS third-party partners 104A3). The spare parts inventory information is a set of predetermined business rules to recommend an optimal source of supply and purchase quantity. Recommended sources of supply include inventory from departments within the demanding spare parts buyer's 106A own company IMS party's 104A1 inventory, IMS partner's 104A2 inventory, IMS third-party partner's 104A3 inventory and OEM spare parts suppliers 107. Information processor 102 matches information in its database regarding each spare part with a spare parts buyer's 106A demand to maximize the potential for usable matched spare parts for buyers 106A. In a preferred embodiment, information processor 102 takes into account multiple customer cataloging systems, parts vendor identifications, and other quality-related program requirements to build a database of parts, to match criteria and use rates. Spare parts buyers 106A preferably provide information regarding use expectations that information processor 102 uses to analyze received buyer 106A demands to ensure optimum order fill results. In case information processor 102 does not find a matched spare part to meet a spare parts buyer's 106A demand, information processor 102 recommends buyer 106A place the demand through traditional channels, such as illustrated in FIG. 1.

Once a request for a spare part is matched with one or more parts known to be in one or more surplus spare parts inventories, the present invention determines optimal order fulfillment recommendations. For example, information processor determines item quantities that available for release, determines demand “matching” based, for example, on the quality and quantity of a spare part, best prices for a spare part and then displays matched results in accordance with a specified display order specified by spare parts buyer 106A.

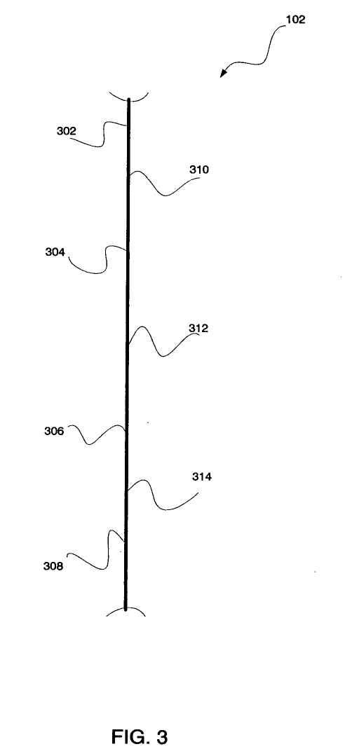

FIG. 3 is a block diagram that shows the functional elements of information processor 102, including one or more central processing units (CPU) 302 used to execute software code and control the operation of information processor 102, read-only memory (ROM) 304, random access memory (RAM) 306, one or more network interfaces 308 to transmit and receive data to and from other computers across communication network 108, storage devices 310 such as a hard disk drive, floppy disk drive, tape drive, CD-ROM or DVD for storing program code databases and application data, one or more input devices 312 such as a keyboard, mouse, track ball, microphone and the like, and a display 314.

The various components of information processor 102 need not be physically contained within the same chassis or even located in a single location. For example, storage device 310 may be located at a site which is remote from the remaining elements of information processor 102, and may even be connected to CPU 302 across communication network 108 via network interface 308. Information processor 102 preferably includes a memory equipped with sufficient storage to provide the necessary databases, forums, and other community services as well as acting as a web server for communicating hypertext markup language (HTML), XML, Java applets, Active-X control programs or the like to workstations 104. Information processors 102 are arranged with components, for example, those shown in FIG. 3, suitable for the expected operating environment of information processor 102. The CPU(s) 302, network interface(s) 308 and memory and storage devices 310 are selected to ensure that capacities are arranged to accommodate expected demand.

The functional elements of information processor 102 shown in FIG. 3 are of the same categories of functional elements present in workstations 104 and 106. However, not all elements need be present in workstations 104 or 106. For example, storage devices, in the case of personal digital assistants (“PDAs”), and the capacities of the various elements are arranged to accommodate the expected user demand. For example, CPU 302 in workstation 104 may be a smaller capacity CPU than the CPU present in information processor 102. Similarly, it is likely that information processor 102 will include storage devices 310 of a much higher capacity than storage devices present in workstation 104. Of course, one of ordinary skill in the art will understand that the capabilities of the functional elements can be adjusted as needed.

One skilled in the art of writing computer executable code (i.e., software) can implement the functions described herein using one or more of a combination of popular computer programming languages and development environments including, but not limited to, C, C++, C#, Visual Basic, JAVA, HTML, XML, ACTIVE SERVER PAGES, JAVA server pages, servlets, and a plurality of web site development applications.

Although the present invention is described by way of example herein and in terms of a web-based system using web browsers and a web site server (e.g., information processor 102), system 100 is not limited to such a configuration. It is contemplated that system 100 is arranged such that workstation 104 communicates with and displays data received from information processor 102 using any known communication and display method, for example, using a non-Internet browser WINDOWS viewer coupled with a local area network protocol such as the Internet Packet Exchange (“IPX”), dial-up, third-party, private network or a value added network (“VAN”).

It is further contemplated that any suitable operating system can be used on information processor 102 and workstations 104, 106, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on information processor 102 workstations 104 and 106 regard the process of communicating data across communication network 108 and processing the data such that the data is viewed on a display 314, for example by using a web browser and the like. As is common with web browsing software, the display 314 on workstation 104 presents sites within the system 100 such that a user can proceed from site to site within the system by selecting a desired link.

Therefore, each user's experience with system 100 is based on the order with which he/she progresses through the display screens. Graphic controls are preferably available in the display screens and modules to initiate data processes, and to provide convenient navigation between the display screens and modules of system 100. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 100.

In a preferred embodiment, the present invention uses three general procedures to determine the most cost effective way to satisfy a spare parts buyer's 106A regular (e.g., daily) spare parts requirements. One procedure regards determining item availability as defined by spare parts seller 104A. A second procedure regards determining whether one or more available spare parts match a spare parts buyer's 106A demand. A third procedure regards display of matched and available spare parts. A discussion of the three procedures is provided below.

Surplus Spare Parts Seller Inventory Information Management

A set of surplus spare parts seller 104A business rules is preferably applied in accordance with the present invention in order to provide inventory transfer recommendations, discount procurement recommendations, parts searching and matching, spare part sourcing and order-fill recommendations.

In accordance with a preferred embodiment, information processor 102 electronically receives information regarding excess spare parts inventory from surplus spare parts seller workstation 104. For example, the information includes descriptions of an OEM spare parts supplier 107, OEM spare parts supplier 107 spare part numbers and spare part descriptive information. The present invention uses the information it receives from surplus spare parts seller workstations 104 to match spare parts to demands received from spare parts buyers 106.

Preferably, surplus supplier workstations 104 transmit information to enable a cross-reference of the surplus spare parts seller's 104A inventory with similar or identical spare parts provided by an OEM spare parts supplier 107. For example, surplus spare parts seller 104A assigns identification number A1000 to a particular relay, and OEM spare parts supplier 107 assigns identification number B1000 for the same relay. In accordance with the present invention, surplus spare parts seller 104A transmits both identification numbers to information processor 102 to enable a cross-reference to the relay. Information processor 102 preferably stores surplus spare parts seller's 104A inventory information such that one or more software routines can use the information to make specific spare part order fulfillment recommendations to spare parts buyers 106A.

In addition to cross-reference information regarding OEM parts supplier 107 information, surplus spare parts seller 104A further transmits cross-reference information regarding alternative spare parts that are interchangeable with an identified spare part. For example, although a particular relay switch may be desired by a particular spare parts buyer 106A, information processor 102 may contain cross-reference information regarding another relay switch that is substantially interchangeable with the desired switch. Information processor 102 identifies interchangeable inventory and recommends such inventory to buyers 106A.

Moreover, surplus spare parts seller 104A transmit information regarding purchase orders of spare parts to information processor 102. Preferably, purchase order information is received from surplus spare parts sellers 104A on a periodic basis and includes the recent purchase orders issued by the surplus spare parts seller's 104A purchasing department. Receiving purchase order information is another technique the present invention uses to maintain current data regarding available spare parts. The purchase order information is used to add new items to the database and to supplement existing parts information with more complete or current information.

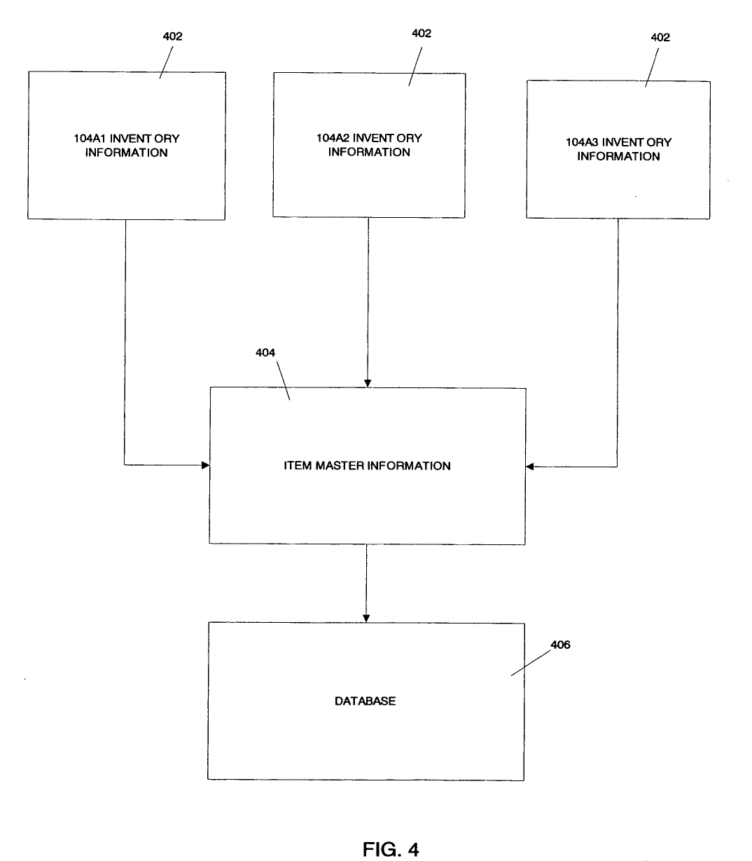

FIG. 4 is a block diagram that illustrates the flow of example spare parts information 402 received from surplus spare parts seller workstations 104 and stored in database 406 by Information processor 102. As noted above, spare parts information 402 preferably includes spare parts information and OEM parts supplier 107 cross-reference information to be used by information processor 102 to recommend spare parts order fulfillment. Preferably, information processor 102 compiles information received from parties 104A1, 104A2 and 104A3 to build a master data file comprising surplus spare part inventory available for spare parts buyers 106. Further, the sending parties will periodically transmit updates to information processor 102 regarding surplus spare parts inventories to ensure current and accurate information.

In accordance with the present invention, various options are provided for surplus spare parts sellers 104A to identify surplus spare parts that are available for sale or other forms of distribution. For example, a surplus spare parts seller 104A indicates it is willing to release items above a minimum defined level. A discussion regarding options provided for surplus spare parts seller 104A is now provided below.

In a preferred embodiment of the present invention, surplus spare parts seller 104A identifies values representing a minimum quantity of a particular spare part (“MIN”), a maximum quantity of the spare part (“MAX”), and an on-hand quantity of the spare part (i.e., the quantity of the spare part the surplus spare parts seller 104A has in its possession) (“ON-HAND”). The present invention applies one or more algorithms that use the MIN, MAX and ON-HAND values to calculate a quantity of a spare part to display to a requesting spare parts buyer 106A and to calculate the remaining balance of spare parts the surplus spare parts seller 104A has in its possession. For example, one algorithm represents any number of spare parts above the MAX value. Another algorithm represents any number of spare parts above the difference of the MAX and the MIN values, divided by two, plus the value of the MIN value (i.e., ((MAX−MIN)/2)+MIN), another algorithm displays a quantity of spare parts equal to the ON-HAND value, and another algorithm displays a quantity of spare parts above the MIN value.

For example, a surplus spare parts seller 104A sets a maximum number of 18 for a particular kind of O-Ring. The surplus spare parts seller 104A has 25 of the O-Rings in its inventory and has identified that it only wants to release for sale the number of O-Rings above its maximum set number. Information processor 102, accordingly, displays a quantity of seven O-Rings that are available for demanding spare parts buyers 106A.

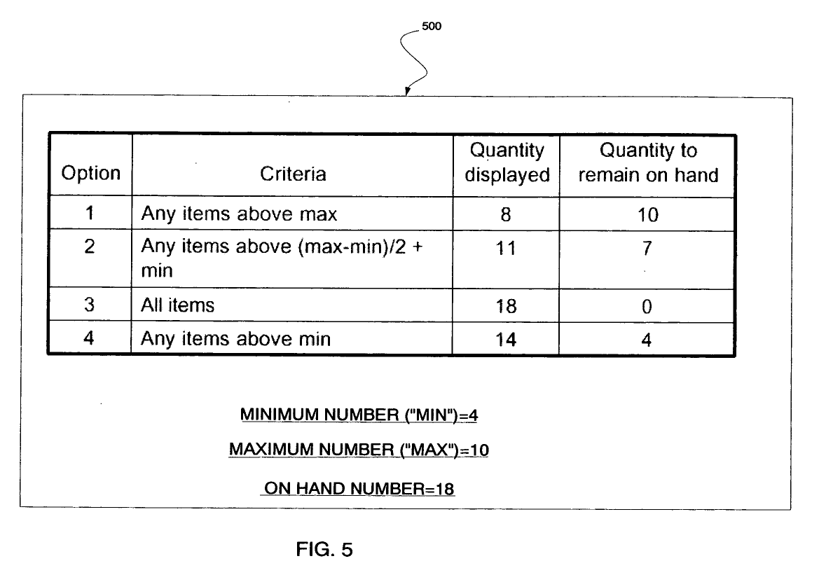

FIG. 5 shows table 500 that illustrates results of the above-identified algorithms and applied according to the present invention. In the example shown in FIG. 5, MIN is equal to 4, MAX is equal to 10 and ON-HAND is equal to 18. The results showing the quantity displayed and remaining quantity on-hand are displayed in table 500.

In accordance with the present invention, the surplus spare parts sellers 104A select the criteria to determine the on hand inventory that is displayed as available. For example, surplus spare parts seller 104A selects from the choices displayed in table 500. More particularly, seller 104A selects whether to display as available the quantity of items above max, the quantity of items above (MAX−MIN)/2+MIN, the entire quantity of items on hand, or the quantity of items above min.

Moreover, the present invention enables surplus spare parts sellers 104A to select whether to restrict items to display for other searching plants within the same company as surplus spare parts sellers 104A, or to plants outside of the company.

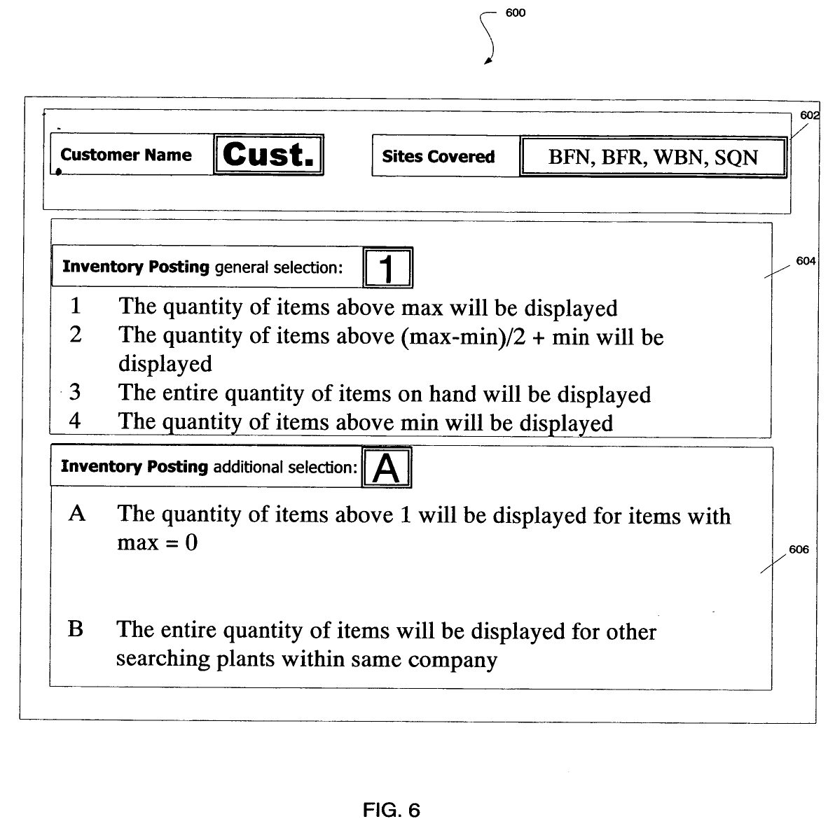

FIG. 6 illustrates a sample display screen 600 that is displayed on surplus spare parts seller workstation 104 that transmits spare parts information 402 (FIG. 4) to information processor 102. As shown in FIG. 6, the surplus spare parts seller 104A identifies in data entry block 602 the name of the surplus spare parts seller 104A and the particular sites or departments within the company supplying the respective spare part. In data entry block 604, the surplus spare parts seller 104A identifies the desired display options according to the algorithms, described above. In data entry block 606, the surplus spare parts seller 104A selects whether to restrict items to display for any quantity of spare parts (identified as “items”) above one for items where the MAX value is equal to zero, or whether the entire quantity of spare parts will be displayed for other searching plants within the same company.

As shown in FIG. 6, the “Inventory Posting general selection” data entry block 604 is provided for surplus spare parts sellers 104A. The “Inventory posting additional selection:” data entry block 606 is an optional section that contains customized business rules that have been requested by a specific surplus spare parts seller 104A. The invention is preferably configurable to accommodate individual customer business needs. In the example shown in FIG. 6, the surplus spare parts seller 104A desires to limit the identification of its inventory that has a MAX value of zero for those items that have an ON-HAND quantity of greater than one. Further, in the example shown in FIG. 6, data entry block 604 enables the entire inventory that is identified as ON-HAND within the same utility's fleet of plants to be viewed. This allows surplus spare parts seller 104A to identify whether one other plants within its company has the particular spare part and, thereafter, to negotiate an internal transfer of material. In a preferred embodiment of the present invention, other surplus spare parts sellers 104A who use the present invention can provide unique business rules that only apply to each surplus spare parts seller's 104A unique business situation.

Preferably, selections of choices are made by using graphic screen controls, such as drop-down lists, checkboxes, radio buttons, text fields or the like.

Surplus Spare Parts Buyer Demand Information Management

Frequently, for example on a daily basis, surplus spare parts buyers 106A create demands for spare parts. The demands are formatted in electronic requests and transmitted information processor 102 for fulfillment. In accordance with a preferred embodiment, information processor 102 compares the electronic spare parts request to information in the database of spare parts to identify matched spare parts that are identified in accordance with the item master information 404, described above.

In accordance with the present invention, the quantity of spare parts that is recommended to spare parts buyers 106A in response to demands is typically very high. Accordingly, spare parts buyers 106A are preferably prompted to select criteria that essentially reduce the quantity of recommendations presented by information processor 102, and to provide a more focused and relevant set of spare parts.

In accordance with a preferred embodiment of the present invention, spare parts buyers 106A are prompted to select two criteria regarding the spare parts they demand: one criteria directed to the quality of the spare part, and one criteria directed to the quantity of the spare part. With respect to quality criteria, spare parts buyers 106A are prompted to direct information processor 102 to display only spare parts having a equal quality level match, to display only spare parts with equal or higher quality level, or to not use quality as any criteria in matching. For example, the quality level that used in the nuclear power industry is typically defined as Levels 1, 2, 3 and 4. A description of each respective level is provided below.

Continuing with respect to the nuclear power industry, Quality Level 1 spare parts are those that are that are manufactured to nuclear industry requirements and/or standards e.g. Title 10 of the Code of Federal Regulations, part 50, Appendix B; ASME section III; IEEE standards 373/374; ANSI; or the like. Quality level 2 items are commercially manufactured items that are not manufactured to nuclear industry standards, but have been tested and verified by the seller or a third party to ensure the item meets the functional requirements of a Quality level 1 item. Quality Level 3 refers to augmented quality items that are commercially available items that were procured with additional requirements to provide a higher level of assurance that the item is acceptable for use. These items may be manufactured to standard commercial industry standards, e.g. UL, NFPA, NEMA, ASTM, or the like. Quality level 4 items are standard industry products that are not required to be manufactured to any specific industry or regulatory requirements or standards.

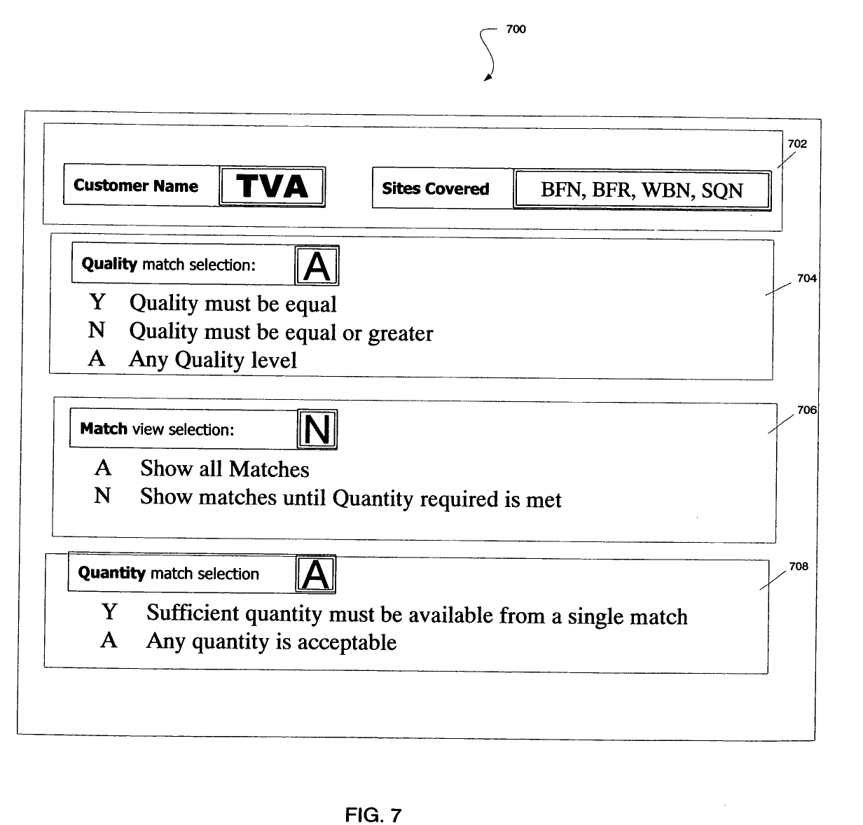

FIG. 7 illustrates a sample display screen 700 that is displayed on spare parts buyer workstation 106 when a demand for one or more spare parts is transmitted. As shown in FIG. 7, spare parts buyer 106A identifies in data entry block 702 the name of the spare parts buyer 106A and the particular sites or departments within the buyer's 106A company demanding the respective spare part. In data entry block 704, the spare parts buyer 106A identifies the desired quality level, which is identified as any quality level. In data entry block 706, the spare parts buyer 106A selects that it wishes to receive all matches, regardless of quantity, and in data entry block 708, the spare parts buyer 106A identifies that it wishes to receive any quantity of the spare part that is matched. Alternatively, as shown in data entry block 708, the spare parts buyer 106A can select whether to receive a sufficient quantity of spare parts that are available from a single match, i.e., all criteria set forth in the buyer's 106A demand are met. Preferably, selections of choices are made by using graphic screen controls, such as drop-down lists, checkboxes, radio buttons, text fields or the like.

Matching Available Spare Parts Inventories with Spare Parts Demands

In accordance with the present invention, information processor 102 applies one or more algorithms to match and locate spare parts inventory for spare parts buyer 106A. The matching steps result in a compilation of information directed to excess inventory levels from several surplus spare parts sellers 104A and matched with specific spare parts buyers 106A demands. Using a graphic user interface and provided in standard web browser software, spare parts buyer 106A uses the information to purchase surplus spare parts inventory.

During the steps associated with locating spare parts for spare parts buyers 106A, information processor 102 preferably compares information in the database directed to spare parts information 402 and information in the demand received by spare parts buyers 106A. Information processor 102 preferably analyzes particular types of information, such as OEM spare parts supplier 107, OEM spare parts supplier 107 part number and spare part descriptive information to make appropriate matches. Thus, the present invention combines keyword and descriptive searching capabilities and searches a significant amount of utility industry specific supplier and supplier part number searching logic.

Once the processes described above regarding surplus spare parts seller 104A inventory information management and surplus spare parts buyer 106A demand information management procedures have been performed, an order fulfillment recommendation are displayed in a manner that is easily understood by spare parts buyer 106A. To determine optimal order fulfillment recommendations, the spare parts buyer 106A preferably selects options for displaying spare parts that are available to fill the order. For example, spare parts buyer 106A selects whether to view only spare parts that are located within the spare parts buyer's 106A company, whether to review only surplus spare parts acquired by a proprietor of information processor 102, or whether to view spare parts on hand at any IMS partner 104A2 and/or IMS third-party partners 104A3. Alternatively, spare parts buyer 106A can select whether to view spare parts that are available only from original OEM spare parts suppliers 107.

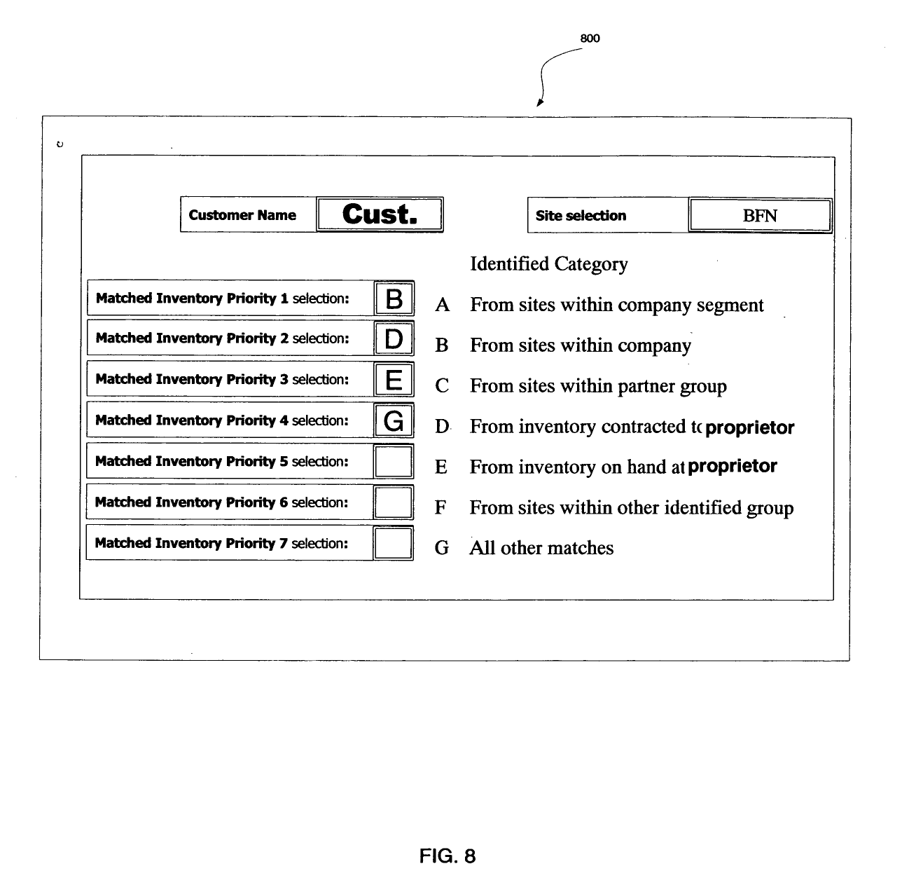

In a preferred embodiment of the present invention, spare parts buyer 106A also identifies desired locations of various priorities for particular spare parts. Priorities of spare parts represent the degree in which a spare part is desired by the spare parts buyer 106A. For example, a particular relay switch may be a very high priority part for a buyer 106, while a particular O-Ring may be a relatively low priority part. The present invention preferably enables a spare parts buyer 106A to select particular categories representing locations of spare parts inventories for respective priorities of spare parts. For example, FIG. 8 illustrates display screen 800 that is provided to a spare parts buyer workstation 106 for matching purposes. As shown in display screen 800, priority 1 matched spare parts inventory has been selected to be obtained from sites within the spare parts buyer's 106A company. Further and as shown in display screen 800, priority 2 spare parts are to be retrieved from inventory located from IMS partners 104A2. Priority 3 spare parts have been selected to be located from IMS parties 104A1, and priority 4 spare parts are identified to be located from any other matched location. Thus, the present invention provides substantial flexibility with respect to identifying locations where spare parts can be obtained, thereby increasing the level of trust spare parts buyer 106A have in the integrity of the spare parts they purchase.

In addition to identifying where specific spare parts should be obtained for purchase, spare parts buyers 106A can also identify precise locations that define sites within spare parts buyers' 106A the company segment, sites within spare parts buyers' 106A company, sites within IMS partners 104A2, sites related to IMS parties 104A1, and sites within other identified groups. By defining exact locations that are represented by the categories shown in FIG. 8, spare parts buyers 106A are assured that the spare parts they purchase via the present invention originate from the locations they define.

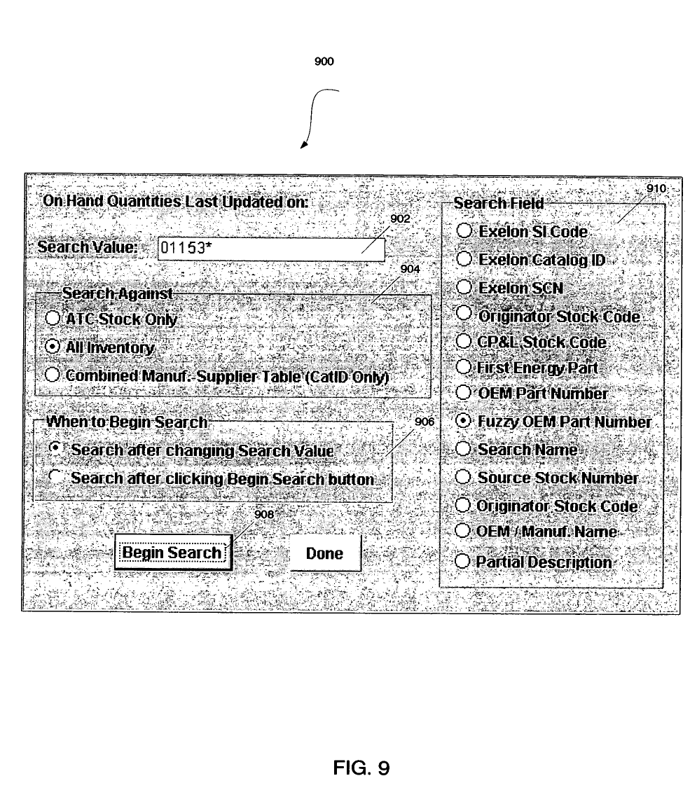

FIG. 9 illustrates an example Internet based display screen 900 that is provided on spare parts buyer workstation 106 to determine particular matching values, such as descriptive information. Text box 902 receives data from a user of spare parts buyer workstation 106 to locate particular spare parts that match the criteria received in text box 902. In the example shown in FIG. 9, the user has submitted a value, 01153*, which represents the starting digits of a spare part identification number. As will be apparent to those skilled in the art, the present invention preferably accepts “wildcard” and other search parameters for added flexibility in searching. Search Against screen portion 904 comprises radio buttons which can be used to identify particular locations for searching for the desired spare part. When to Begin Search screen portion 906 defines a parameter for beginning the search process, i.e., after a value in text box 902 changes or after the user selects graphic screen control button 908. Additionally, Search Field screen portion 910 comprises radio buttons for identifying the context of text box 902. For example, text box 902 may represent a part number, a stock code, a partial description, or the like. By selecting a screen control in Search Field screen portion 910, the user can dynamically determine the context for searching the value provided in text box 902.

Order Fulfillment Notification and Reporting

After the matching processes, described above, are complete, one or more matching and available spare parts are located by information processor 102. Spare parts buyers 106A are provided results of their demands in accordance with the surplus spare parts sellers' 104A rules, the price the parts are provided for, and the estimated savings obtained by purchasing the parts via the present invention. Spare parts buyers 106A are preferably able to sort on different fields in the results display screen, and can further search for particular spare parts using, for example, internal item identification numbers.

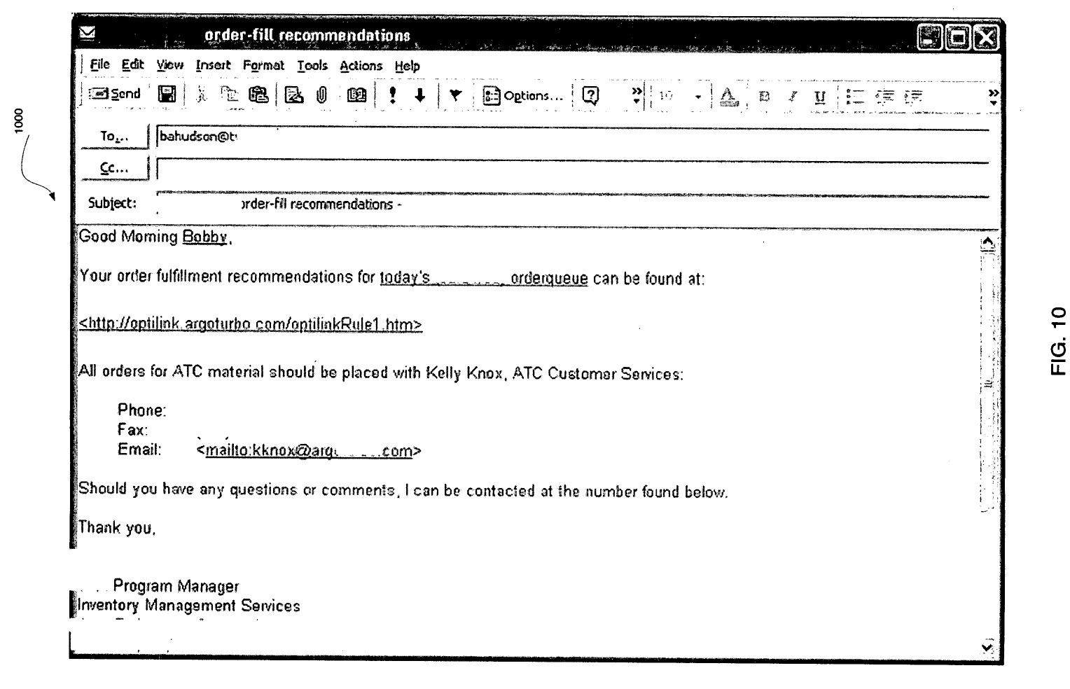

FIG. 10 shows an example e-mailed notification display screen 1000 that is provided to spare parts buyer 106A after a demand for spare parts has been received and processed. In a preferred embodiment of the present invention, security measures are provided to restrict users from searching for or receiving information regarding spare parts unless those users have proper authorization. For example, information processor 102 maintains a database of authorized users of the present invention and restricts access to the display screens and information described herein to those authorized parties. Password-protected access levels are maintained, such as for operators, engineers/modelers, managers, database administrators, and associated functionality is accessible for those operating within each access level.

In the example shown in FIG. 10, an authorized user receives notification regarding a spare part demand via e-mail. As shown in FIG. 10, e-mailed display screen 1000 includes a hyperlink to a secured Internet web site where information regarding results of the spare part demand can be viewed. Preferably, the user submits a registered user name and password in order to access the Internet site represented by the hyperlink.

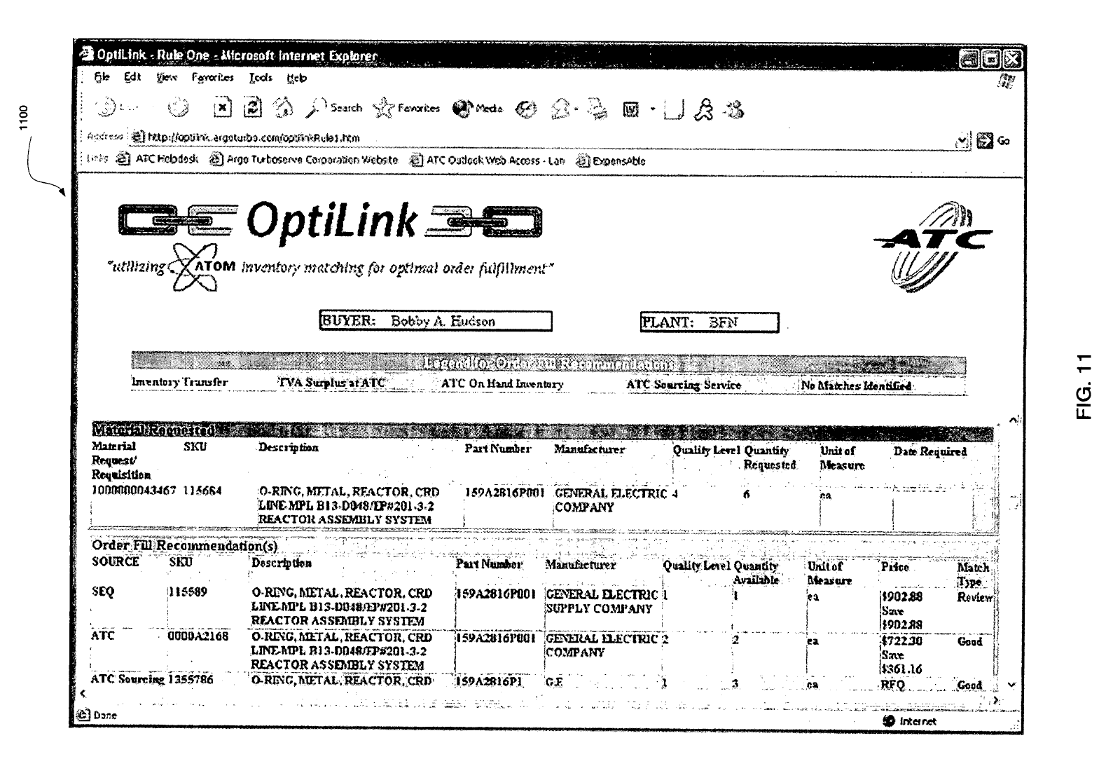

FIG. 11 illustrates an example Internet-based display screen 1100 that provides results from a spare parts demand that a spare parts buyer 106A submitted via information processor 102. The results of the search are provided such that results can be viewed using a standard web browser software application, and eliminates the need for expensive and proprietary software that must be installed, for example, on the spare parts buyer workstation 106.

As shown in FIG. 11, spare parts buyer 106A requested a particular O-Ring. Display screen 1100 indicates a plurality of sources where the O-Ring can be obtained, the SKU of the O-Ring, a description of the O-Ring, the part number and manufacturer of the O-Ring, the quality match of the buyer's 106A request and each respective O-Ring returned by the search, the quantity of O-Rings that are available from each respective source, a unit of measure, a respective price and corresponding price savings and a match type (representing the degree in which the returned results match the buyer's 106A demand). Furthermore, display screen 1100 is preferably color coded to represent whether the order fill is an inventory transfer from within the spare parts buyer's 106A own company, or, alternatively, originates from an IMS party 104A1, an IMS partner 104A2, or an IMS third-party partner 104A3, as defined above.

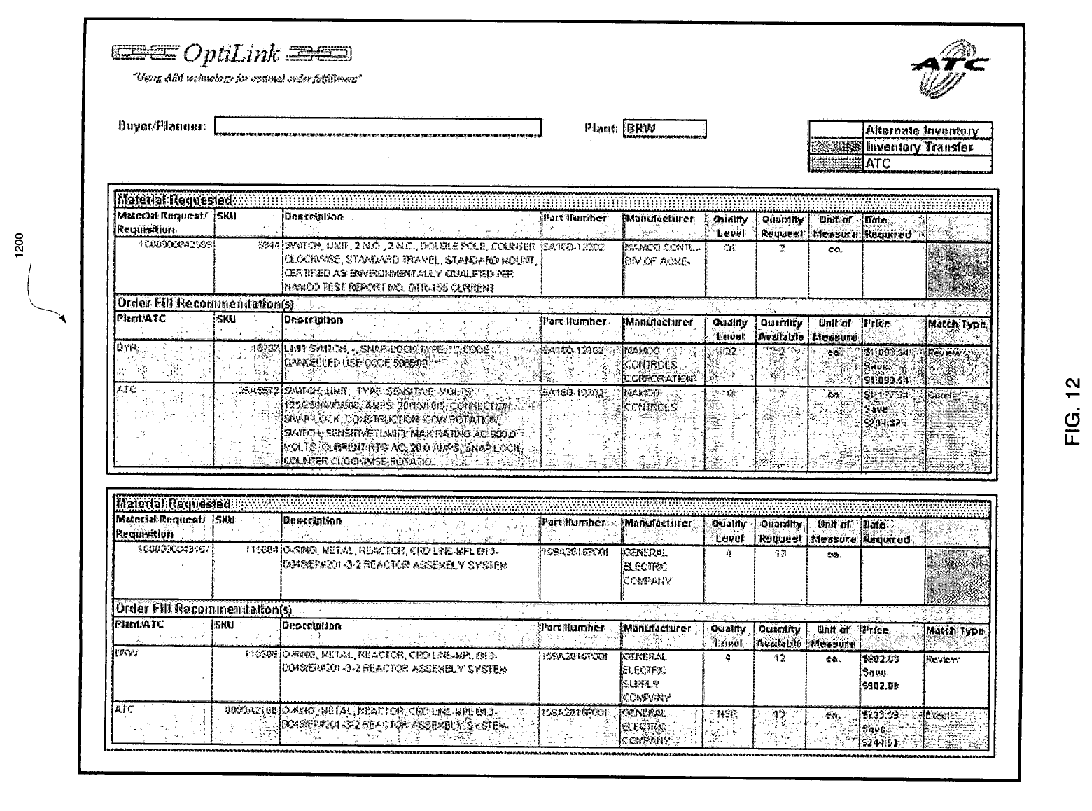

FIG. 12 is an example display screen 1200 that also illustrates results returned from a spare parts buyer 106A demand for spare parts. FIG. 12 illustrates many of the same elements described above with respect to FIG. 11, and also illustrates that a request for a plurality of spare parts (identified as “Materials Requested”) was received from spare parts buyer 106A and a plurality of spare parts is returned by information processor 102 in response thereto.

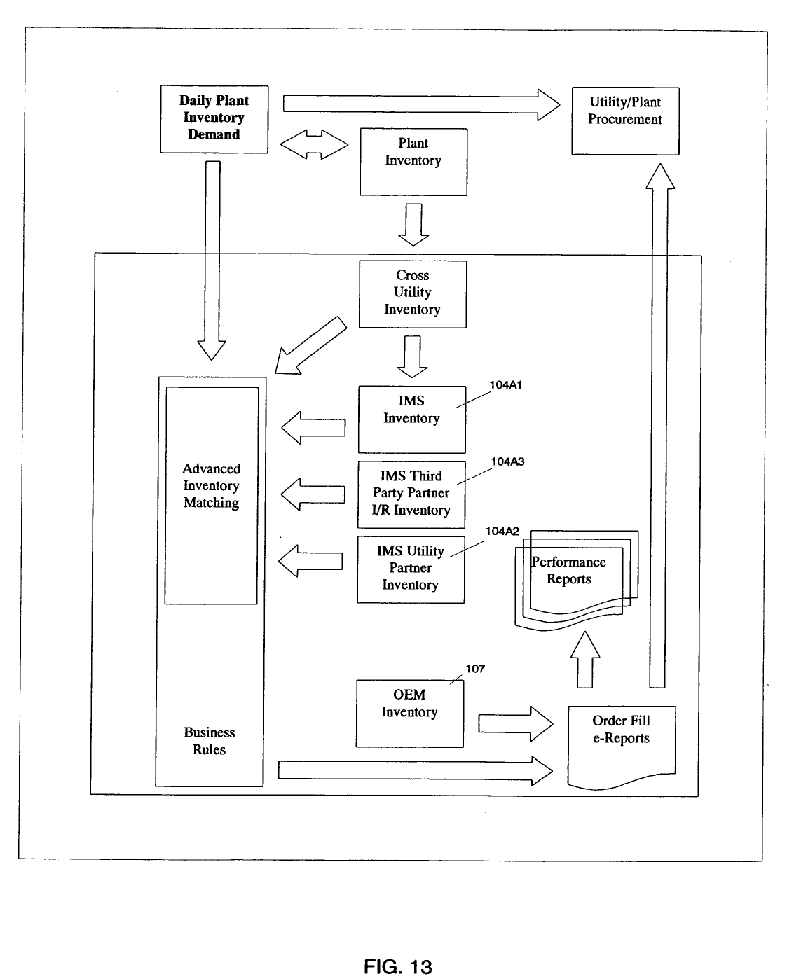

FIG. 13 is a block diagram that illustrates a high level flow of information between the various parties associated with the present invention. As shown in FIG. 13, information regarding various spare part inventories, including a spare parts buyer's 106A internal plant, IMS parties 104A1, IMS partners 104A2, and IMS third-party partners 104A3 is received by information processor 102. Further, spare part inventory demands are received by information processor 102, and the processes described above with respect to matching available spare part inventories are performed. In the event that the demanded spare parts cannot be located by the above parties, then OEM spare parts supplier 107 spare part inventory is referenced. Reports regarding order fulfillment are provided and spare parts procurement is enabled.

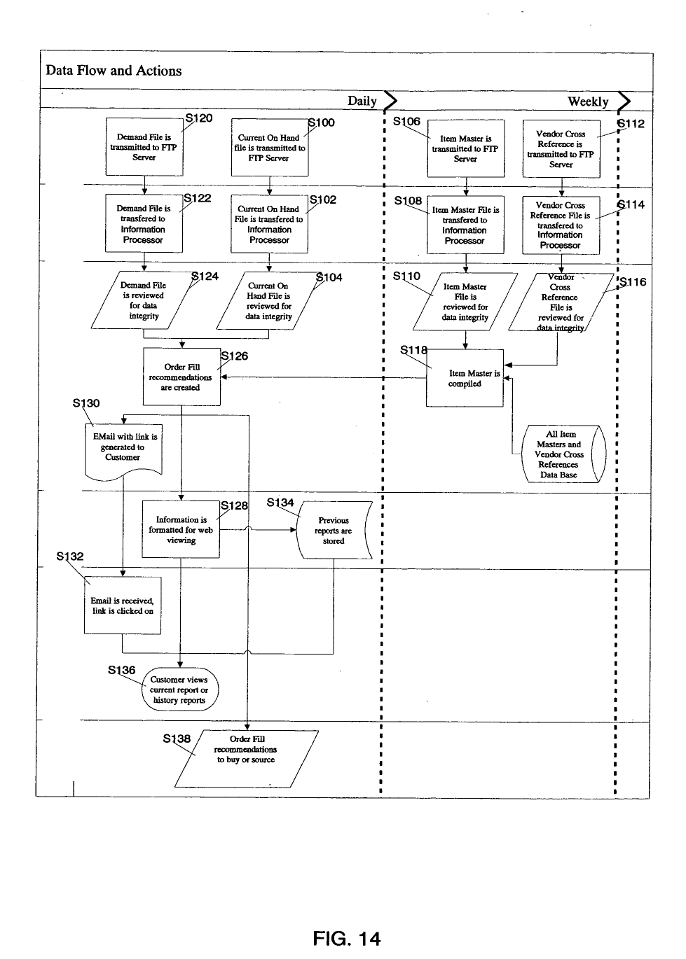

FIG. 14 is a flow chart that illustrates example steps associated with the above-described processes. A brief discussion regarding the steps listed in FIG. 14 will now take place.

As shown in FIG. 14, steps are performed on a daily basis and on a weekly basis. In step S100, an electronic file representing a current on-hand spare parts inventory is provided daily by surplus spare parts seller 104A is transmitted to a file transfer protocol (“FTP”) server and, thereafter, transmitted to information processor 102 (step S102). Once received, the on-hand inventory file is reviewed for data integrity (step S104). For example, rules directed to data formatting and content must be adhered to before an electronic file can be properly processed by information processor 102. In step S106, an item master file is transmitted weekly to the FTP server by the surplus spare parts sellers 104A, and, thereafter, transmitted to information processor 102 (step S108). Again, the data file is reviewed for data integrity (step S110). Also, in step S112, a vendor cross-reference electronic information file is transmitted to an FTP server, and, thereafter, to information processor 102 (step S114). The vendor cross-reference file is checked integrity in step S116. In step S118, an item master information file 404 is compiled.

In addition to steps performed regarding surplus spare parts sellers 104A, spare parts buyer 106A transmits a demand file to an FTP server in step S120, and the demand file is transmitted to information processor 102 (step S122). In step S124, the demand file is reviewed for data integrity.

Once the demand file and the item master file 404 are received by information processor 102, order fill recommendations are created (step S126). The information regarding the order fill recommendations are formatted for viewing using standard Internet web browser software (step S128). In step S130, an e-mail message comprising a hyperlink to the formatted information is generated and transmitted to spare parts buyer 106A. In step S132, the e-mail is received by spare parts buyer 106A, the hyperlink is selected, and the spare parts buyer 106A, in step S136, views the information. In step S134, the information reports are archived for future viewing. Once the spare parts buyer 106A has reviewed the information regarding available and matched spare parts, order fill recommendations to purchase or source the spare parts, for example, from within the spare parts buyer's 106A company are made (step S138). Thus, information regarding spare parts inventory and spare parts demands are received by information processor 102, and recommendations for order fulfillment are provided.

Thus, the present invention provides a convenient and intuitive interface for reporting availability of spare parts in response to a particular demand placed by a spare parts buyer 106A. The interface provides a color-coded web-based display that includes pertinent information regarding the spare parts. Further, the interface is secure and restricted to authorized personnel.

Spare Parts Procurement

In one embodiment of the present invention, a proprietor of information processor 102 purchases excess inventory from surplus spare parts sellers 104A and holds the inventory for eventual sale to a demanding spare parts buyer 106A. In an alternative embodiment, the proprietor of information processor 102 identifies physical locations (e.g., warehouses) where spare parts inventory is located, and after the demanding spare parts buyer 106A indicates an intention to purchase such inventory, the proprietor of information processor 102 purchases the spare parts and, thereafter, sells it to the spare parts buyer 106A.

In another embodiment, the proprietor of information processor 102 purchases surplus spare parts inventory from a surplus spare parts seller 104A, and then returns the inventory to the seller 104A (now acting in the capacity as spare parts buyer 106A) upon receiving a demand for the same inventory.

In yet another embodiment, the proprietor of information processor 102 identifies a separate department or division within a single business entity that functions as a surplus spare parts seller 104A. Information processor 102 identifies another department or division within the single entity that requests the same spare parts inventory. Information processor 102 provides the location of the spare parts inventory to the demanding department (functioning as a spare parts buyer 106A) for a fee. Such an exchange is referred to herein as an inventory transfer. In the prior art, available excess inventory levels within a department of a business entity are not readily discoverable by other departments in that business entity. The present invention enables efficient internal transfers of inventory, and eliminates the need to transact for new inventory directly from an OEM spare parts supplier 107, or even from an end-user in another business entity who desires to dispose of excess inventory.

### Conclusion

The present invention provides benefits in various forms, including cost savings and reliable data exchange. One benefit the present invention provides over prior art spare parts procurement is the ability of spare parts buyers 106A to trust the data provided by information processor 102. One way the present invention accomplishes this benefit is by posting surplus spare parts sellers' 104A spare parts inventory over the Internet, partially to assure that matched parts will be released. Thus, an individual surplus spare parts seller 104A and the information processor 102 are able to review criteria and identify items as available.

Further, on-going costs savings/inventory benefits associated with obtaining spare part inventories are realized. The present invention has been developed specifically with parties requiring spare parts in mind, and contains a significant amount of utility industry specific supplier and supplier part number searching logic. Accordingly, the present invention consistently outperforms other popular search engines when applied to utility spare part searching and matching.

Although the present invention has been described in relation to particular embodiments thereof, many other variations and modifications and other uses will become apparent to those skilled in the art. For example, many of the examples cited herein refer to the nuclear power industry. Of course, one skilled in the art will recognize that the invention is not so limited. Any industry that relies on machinery which require replacement spare parts can benefit from the features described herein. It is preferred, therefore, that the present invention be limited not by the specific disclosure herein.

1. A method for providing electronic spare parts information to a buyer over a communication network, the method comprising:
receiving from a plurality of surplus spare parts sellers electronic spare parts inventory information representing at least one spare part and representing availability of the at least one spare part;
storing the electronic inventory information in a database;
receiving from a spare parts buyer electronic spare parts demand information representing at least a demand for at least one spare part;
matching the electronic spare parts demand information with the electronic inventory information stored in the database to identify at least one matched spare part;
determining from the electronic spare parts inventory information whether the at least one matched spare part is available from the at least one of the plurality of surplus spare parts sellers;
providing electronic spare parts information representing the matched spare part when the at least one matched spare part is available from at least one of the plurality of surplus spare parts sellers; and
electronically providing the electronic spare parts information to the spare parts buyer.

2. The method of claim 1, further comprising providing the at least one matched spare part to the spare parts buyer in response to a request from the spare parts buyer for the spare part when the at least one matched spare part is available.

3. The method of claim 2, wherein the step of providing the at least one matched spare part comprises purchasing the at least one matched spare part from the at least one surplus spare parts seller and reselling the available spare part to the spare parts buyer.

4. The method of claim 1, wherein the plurality of surplus spare parts sellers comprises at least one of an inventory management services party, an inventory management services partner and an inventory management services third-party partner.

5. The method of claim 1, wherein the electronic spare parts inventory information further comprises a minimum value representing a minimum quantity of respective one of the at least one spare part, a maximum value representing a maximum quantity of respective one of the at least one spare part, and an on-hand value representing a quantity of respective one of the at least one spare part.

6. The method of claim 5, further comprising storing in the database electronic spare parts inventory availability criteria information representing criteria for determining a quantity of each respective one of the at least one spare part that is available for a spare parts buyer and further for determining a quantity of each respective one of the at least one spare part that is not available for a spare parts buyer.

7. The method of claim 6, wherein the electronic spare parts inventory availability criteria information represents a quantity of each respective one of the at least one spare part that is available for a spare parts buyer by calculating at least one of:
the difference of the on-hand value and the maximum value;
the difference of the on-hand value and the (difference of the maximum value and the minimum value) divided by a value of 2 plus the minimum value;
the value of the on-hand value; and
the difference of the on-hand value and the minimum value.

8. The method of claim 5, further comprising receiving from a respective one of the plurality of surplus spare parts sellers electronic availability criteria information representing rules for determining whether each respective one of the at least one spare part is available for a spare parts buyer based on at least one of the minimum value, the maximum value and the on-hand value.

9. The method of claim 8, further comprising receiving from at least one of the plurality of surplus spare parts sellers an electronic selection representing at least one criteria represented by the electronic spare parts inventory availability criteria information.

10. The method of claim 1, wherein the electronic spare parts demand information further represents at least spare parts display criteria for matching the electronic spare parts demand information with the electronic inventory information.

11. The method of claim 10, wherein the spare parts display criteria includes at least one of:
whether the at least one matched spare part is equal in quality to a spare part represented in the demand;
whether the at least one matched spare part is at least equal in quality to a spare part represented in the demand; and
whether the at least one matched spare part is of any quality.

12. The method of claim 10, wherein the electronic spare parts demand information further comprises a spare parts value representing a quantity of spare parts demanded by the spare parts buyer, and wherein the spare parts display criteria includes whether the number of the at least one matched spare part equals at least the spare parts demand quantity.

13. The method of claim 1, further comprising receiving from the spare parts buyer electronic priority information representing a plurality of categories of spare parts representing respective sources of each respective one of the plurality of categories, wherein the electronic spare parts demand information represents at least a demand for a plurality of spare parts.

14. The method of claim 13, wherein the plurality of categories include at least two of:
sites within a company segment;
sites within a company;
sites within an inventory management services party;
sites within an inventory management services partner; and
sites within an inventory management services third-party partner.

15. The method of claim 1, wherein the electronic spare parts demand information further comprises a search value representing at least an entire one or portion of:
a spare parts identification value assigned by an original equipment manufacturer;
a spare parts identification value assigned by the spare parts buyer;
a spare parts identification value assigned by a surplus spare parts seller;
a textual description of the spare part; and
a name of an original equipment manufacturer.

16. The method of claim 15, wherein the step of matching the electronic spare parts demand information with the electronic inventory information further comprises providing criteria to limit the step of matching to a search for at least one of:
inventory held by an inventory management services party;
inventory provided an original equipment manufacturers; and
all inventory represented in the database.

17. The method of claim 1, wherein the step of providing the electronic spare parts information to the spare parts buyer further includes transmitting an e-mail message to the spare parts buyer, wherein the e-mail message includes a uniform resource locator representing an Internet web site that displays the electronic spare parts information.

18. The method of claim 1, wherein the step of providing the electronic spare parts information to the spare parts buyer includes providing an Internet web site that displays the electronic spare parts information.

19. The method of claim 1, wherein the electronic spare parts information represents at least one of selected from the group consisting of:
an inventory transfer;
inventory management services party inventory;
inventory management services partner inventory;
inventory management services third-party partner inventory;
a materials requisition value;
a SKU number;
a description of the spare part;
a spare part number;
a manufacturer of the spare part;
a quality level of the spare part;
a quantity requested by the spare parts buyer;
a unit of measure;
a delivery date;
a price for the space part;
a calculated difference between the price and an amount charged for the matched spare part by an original equipment manufacturer; and
a value representing a degree in which the matched spare part matches the electronic spare parts demand information.

20. The method of claim 1, wherein the communication network is the Internet.

21. A system for providing electronic spare parts information to a buyer over a communication network, the system comprising:
an electronic spare parts information module operable to receive from a plurality of surplus spare parts sellers electronic spare parts inventory information representing at least one spare part and representing availability of the at least one spare part;
an electronic database operable to store the electronic inventory information;
an electronic spare parts demand information module operable to receive from a spare parts buyer electronic spare parts demand information representing at least a demand for at least one spare part;
an electronic matching module operable to match the electronic spare parts demand information with the electronic inventory information stored in the database to identify at least one matched spare part;
an electronic availability module operable to determine whether the at least one matched spare part is available from the at least one of the plurality of surplus spare parts sellers, wherein the electronic availability module basis the determination at least in part on the electronic spare parts inventory information;
an electronic spare parts information module operable to provide electronic spare parts information representing the at least one matched spare part when the at least one matched spare part is available from at least one of the plurality of surplus spare parts sellers; and
a transmission module operable to electronically provide the electronic spare parts information to the spare parts buyer.

22. The system of claim 21, further a purchasing module operable to provide the at least one matched spare part to the spare parts buyer in response to a request from the spare parts buyer for the at last one spare part.

23. The system of claim 22, wherein the purchasing module purchases the at least one matched spare part from the at least one surplus spare parts seller and resells the available spare part to the spare parts buyer.

24. The system of claim 21, wherein the plurality of surplus spare parts sellers comprises at least one of an inventory management services party, an inventory management services partner and an inventory management services third-party partner.

25. The system of claim 21, wherein the electronic spare parts inventory information further comprises a minimum value representing a minimum quantity of respective one of the at least one spare part, a maximum value representing a maximum quantity of respective one of the at least one spare part, and an on-hand value representing a quantity of respective one of the at least one spare part.

26. The system of claim 25, wherein the electronic database is further operable to store electronic spare parts inventory availability criteria information representing criteria for determining a quantity of each respective one of the at least one spare part that is available for a spare parts buyer and further for determining a quantity of each respective one of the at least one spare part that is not available for a spare parts buyer.

27. The system of claim 26, wherein the electronic spare parts inventory availability criteria information represents a quantity of each respective one of the at least one spare part that is available for a spare parts buyer by calculating at least one of:
the difference of the on-hand value and the maximum value;
the difference of the on-hand value and the (difference of the maximum value and the minimum value) divided by a value of 2 plus the minimum value;
the value of the on-hand value; and
the difference of the on-hand value and the minimum value.

28. The system of claim 25, further comprising a data entry module operable to receive from a respective one of the plurality of surplus spare parts sellers electronic availability criteria information representing criteria for determining whether each respective one of the at least one spare part is available for a spare parts buyer based on at least one of the minimum value, the maximum value and the on-hand value.

29. The system of claim 28, further wherein the data entry module is further operable to receive from at least one of the plurality of surplus spare parts sellers an electronic selection representing at least one criteria represented by the electronic spare parts inventory availability criteria information.

30. The system of claim 21, wherein the electronic spare parts demand information further represents spare parts display criteria for matching the electronic spare parts demand information with the electronic inventory information.

31. The system of claim 30, wherein the spare parts display criteria includes at least one of:
whether the matched spare part is equal in quality to a spare part represented in the demand;
whether the matched spare part is at least equal in quality to a spare part represented in the demand;
whether the matched spare part is of any quality.

32. The system of claim 30, wherein the electronic spare parts demand information further comprises a spare parts value representing a quantity of spare parts demanded by the spare parts buyer, and wherein the spare parts display criteria includes whether the number of matched spare parts equals at least the spare parts demand quantity.

33. The system of claim 21, further comprising a data entry module operable to receive from the spare parts buyer electronic priority information representing a plurality of categories of spare parts demanded by the spare parts buyer and representing respective sources of each respective one of the plurality of categories, wherein the electronic spare parts demand information represents a demand for a plurality of spare parts.

34. The system of claim 33, wherein the plurality of categories include at least two of:
sites within a company segment;
sites within a company;
sites within an inventory management services party;
sites within an inventory management services partner; and
sites within an inventory management services third-party partner.

35. The system of claim 21, wherein the electronic spare parts demand information further comprises a search value representing at least an entire one or portion of:
a spare parts identification value assigned by an original equipment manufacturer;
a spare parts identification value assigned by the spare parts buyer;
a spare parts identification value assigned by a surplus spare parts seller;
a textual description of the spare part; and
an original equipment manufacturer name.

36. The system of claim 35, wherein the matching module is further operable to locate spare parts originating from at least one of:
inventory held by an inventory management services party;
inventory provided an original equipment manufacturers; and
all inventory represented in the database.

37. The system of claim 21, wherein the transmission module is further operable to transmit an e-mail message to the spare parts buyer, wherein the e-mail message includes a uniform resource locator representing an Internet web site that displays the electronic spare parts information.

38. The system of claim 21, wherein the electronic spare parts information module is further operable to provide an Internet web site that displays the electronic spare parts information.

39. The system of claim 21, wherein the electronic spare parts information represents at least one of selected from the group consisting of:
an inventory transfer;
inventory management services party inventory;
inventory management services partner inventory;
inventory management services third-party partner inventory;
a materials requisition value;
a SKU number;
a description of the spare part;
a spare part number;
a manufacturer of the spare part;
a quality level of the spare part;
a quantity requested by the spare parts buyer;
a unit of measure;
a delivery date;
a price for the space part;
a calculated difference between the price and an amount charged for the matched spare part by an original equipment manufacturer; and
a value representing a degree in which the matched spare part matches the electronic spare parts demand information.

40. The system of claim 21, wherein the communication network is the Internet.
